(19) United States
(12) Patent Application Publication
(10) Pub. No.: US 2003/0046710 A1
(43) Pub. Date: Mar. 6, 2003

(54) Multi-media communication system for the disabled and others

(76) Inventor: John F. Moore, Libertyville, IL (US)

Correspondence Address: Jon P. Christensen, Welsh & Katz, Ltd., 22nd Floor, 120 South Riverside Plaza, Chicago, IL, 60606, US

(21) Appl. No.: 09/946,918

(22) Filed: Sep. 5, 2001

(51) Int. Cl. H04N 7/173

(52) U.S. Cl. 725/133; 725/110

(57) ABSTRACT

A method and apparatus are described for providing access by a user to a resource through one of a plurality of communication systems. The method includes the steps of releasably connecting a microphone to a body part of the user, detecting a voice signal of the user through the connected microphone and transferring the detected voice signal of the user detected by the microphone to a local base unit. The method further includes the steps of recognizing at least some spoken words of the user, associating the recognized words with a predetermined communication system of the plurality of communication systems, executing a predetermined command to gain access to the resource based upon the recognized words through the associated communication system and displaying a status screen regarding the accessed resource on a television set of the user.

### FIELD OF THE INVENTION

The field of the invention relates to the disabled and more particularly to communication systems adapted to the needs of the disabled.

### BACKGROUND OF THE INVENTION

Communication devices for the disabled have generally been limited to relatively specialized devices for specific purposes. Medic Alert, for example, is a pushbutton device that may be placed around the neck of the user as a pendant. Upon the advent of a medical crisis, a wearer may activate a button on the pendant.

Upon activation of the button, the pendant transmits an alerting signal to a base station attached to a telephone of the user. Upon receiving the alert, the base station may dial a telephone number of a local emergency services organization. Upon completing a telephone connection, the base station may play back a pre-recorded message identifying an address of the emergency.

While devices such as Medic Alert are effective, they are only generally offered to a limited group of people at risk. Further, even where such devices are available, they are often not reliable. Such devices are often subject to accidental activation and false alarms. Even when intentionally activated, the possibility of a dead battery may interfere with the reliable reporting of an actual emergency.

Because of the nature of the reporting protocol of devices such as Medic Alert, emergency service dispatchers are often left to guess at the type of emergency involved. Since Medic Alert devices are often issued for specific medical conditions, the activation of such devices for other purposes (e.g., a fire) may easily cause in inappropriate response to an actual emergency. Because of the importance of communication to disabled persons, a need exists for a more flexible means of communication which supports the various needs of a broader group of people at risk (herein referred to generally as “disabled persons”) and others not at risk, such as people who dislike computers or typewriters, those with hearing loss, the elderly, etc.

### SUMMARY

A method and apparatus are described for providing access by a user to a resource through one of a plurality of communication systems. The method includes the steps of releasably connecting a microphone to a body part of the user, detecting a voice signal of the user through the connected microphone and transferring the detected voice signal of the user detected by the microphone to a local base unit. The method further includes the steps of recognizing at least some spoken words of the user, associating the recognized words with a predetermined communication system of the plurality of communication systems, executing a predetermined command to gain access to the resource based upon the recognized words through the associated communication system and displaying a status screen regarding the accessed resource on a television set of the user.

### BRIEF DESCRIPTION OF THE DRAWINGS

FIG. 1 depicts a multi-media communication system for the disabled in accordance with an illustrated embodiment of the invention;

FIG. 2 is a block diagram of the system of FIG. 1;

FIG. 3 is a key-word in context command list that may be used by the system of FIGS. 1 and 2;

FIG. 4 depicts the UseFullWatch of the system of FIG. 1; and

FIG. 5 depicts the UseFullBox of the system of FIG. 1.

### BRIEF DESCRIPTION OF AN ILLUSTRATED EMBODIMENT

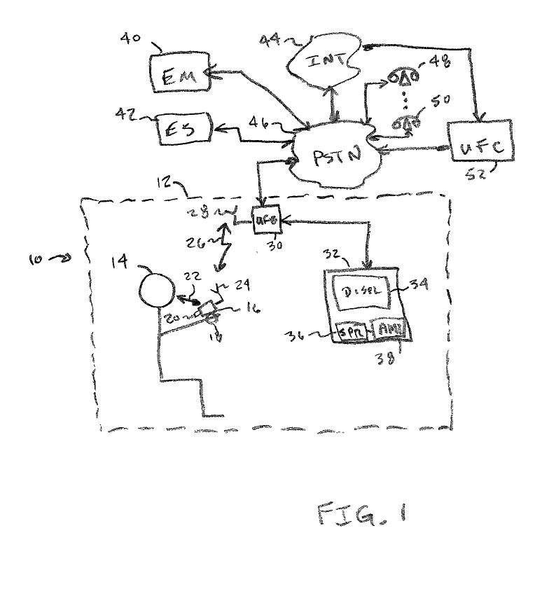

FIG. 1 depicts an information retrieval and reporting system (UseFullNet) 10 (shown generally under illustrated embodiments of the invention) that may be used to great advantage by a disabled person. In general, the UseFullNet system 10 includes a portable, body-mounted device (e.g., wrist-worn, neck-worn pendant, etc.), which is herein referred to as a “UseFullWatch” 16; a stationary device (UseFullBox) 30, located within the home 12 of the user and an external device (UseFulCenter) 52 that may be coupled to the UseFullBox 30 through the public switched telephone network (PSTN) 46, or through an appropriate internet connection (e.g., cable, cellular radio, satellite, etc.).

In overview, the UseFullWatch 16 may include a microphone adapted to detect voice instructions 22 of the user 14. A wireless transmitter within the UseFullWatch 16 may transfer the voice signal to the UseFullBox 30 through a wireless link 26. In one embodiment, the UseFullBox 30, in turn, transfers the voice signal to the UseFulCenter 52 through the PSTN 46. In addition, certain limited voice recognition features may be included in the UseFullBox 30, as discussed in more detail below. Within the UseFulCenter 52, a more comprehensive version of the voice recognition software may detect, interpret and execute the user's spoken instructions. In another embodiment, full vocabulary voice recognition software within the UseFullBox 30 may interpret the spoken instructions into standard computer code, and send that code to the UseFulCenter 52, where it is executed.

Textual confirmation of the spoken or code instructions, options or requests for clarification may be returned from the UseFulCenter 52, through the UseFullBox 30, and displayed on a television 32 of the user 14. In the case of options or requests for clarifications, the UseFulCenter may wait for further instructions before executing a command. Where instructions from the user 14 are unambiguous, the UseFulCenter 52 may immediately begin executing an instruction and simply send confirmation for display on the television 32 of the user 14.

Turning first to the UseFullNet 10, in general, an explanation will be offered of the communication links operating within the system 10. Following an explanation of the communication links, an explanation will be offered of how the system 10 may allow the user 14 to access resources through a number of different communication channels.

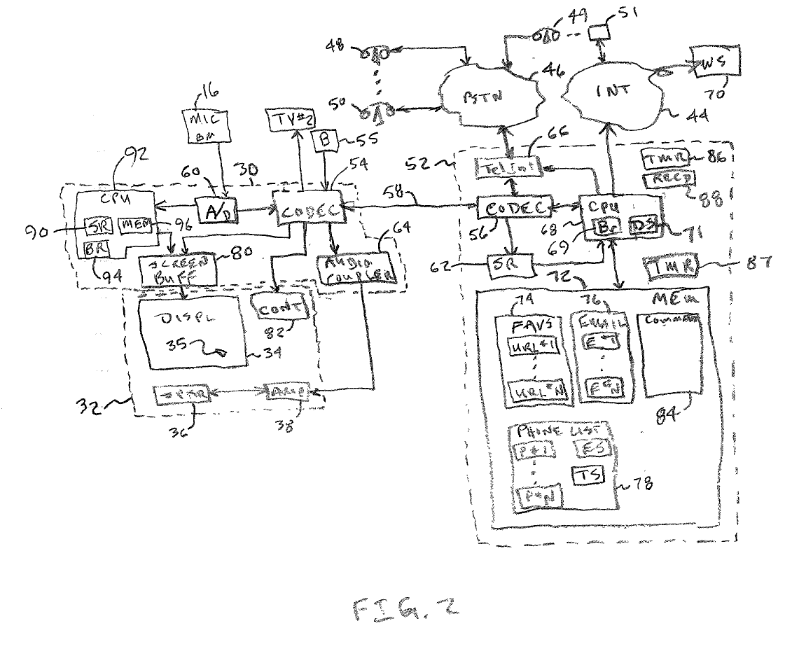

FIG. 2 is a block diagram showing more detail of the UseFullBox 30 and UseFulCenter 52. As shown, the UseFullBox 30 and UseFulCenter 52 may be coupled through the use of respective coder/decoders (codec) 54, 56. The codecs 54, 56, in turn, may be coupled, one-to-another, through the use of an appropriate communication medium (e.g., dial-up connection, leased line, cable, satellite, cellular radio, virtual private line, etc.). The connection may be routed directly to the UseFulCenter 52 or indirectly, through a commercial internet service bureau (ISB).

Codecs 54, 56 may be any programmable device capable of providing a number of independent, substantially transparent communication channels between respective ports (i.e., terminals) of the codecs 54, 56. For example, a first set of code plugs may couple a voice signal received on a first terminal of the first codec 54 from an analog-to-digital (A/D) converter 60 to a speech recognition (SR) module 62 through a respective terminal of the second codec 56. Similarly, a second set of code plugs within the codecs 54, 56 may be used for the two-way exchange of voice information between the telephone interface 66 and audio coupler 64. A third set of code plugs may couple information from the central processing unit (CPU) 68 to the screen buffer 80. A fourth set of code plugs may couple information from the CPU 68 to a controller 82 of the television 32. As would be apparent to those of skill in the art, the code plugs may be replaced by other structure with the same function, that may become available as a result of advances in technology.

The UseFullBox 30 may also include a CPU 92 with a browser 94 and a speech recognition module 90. The UseFullBox CPU 92 may be coupled to UseFullCenter CPU 68 through a fifth set of code plugs within the codecs 54, 56. The presence of the browser 92 within the UseFullBox 30 may allow information to be downloaded from the UseFullCenter 52 under an HTML format and converted into a raster format within the browser 92, thereby reducing the volume of data that must be transferred between the UseFullCenter 52 and UseFullBox 30.

The speech recognition module 90 may be of a relatively limited capacity and be intended to provide a limited audio interface for control of the browser 92. For example, the recognition of such simple control words such as “UP”, “DOWN”, “GO” by the module 90 may be used to activate and control corresponding display features within the browser 92.

Returning now to the system 10, a number of examples will be offered of the use of the system 10. For example, the system 10 may be used to set up telephone calls using the television 32 as a speakerphone. In the case of outgoing calls, the user 14 may activate a button 20 on his UseFullWatch 16 and say “CALL” or “CALL BOB”. The microphone detects the instruction and transfers it to UseFullBox 30. From the UseFullBox 30, the instruction is transferred to the UseFulCenter 52 and, ultimately, to the SR module 62.

Within the SR 62, the enunciated words may be recognized and processed accordingly. To process the words, the CPU 68 may make a word association between enunciated words and an expected response. To make the word association, the CPU 68 may enter a key word command list 84 using the enunciated words as an index.

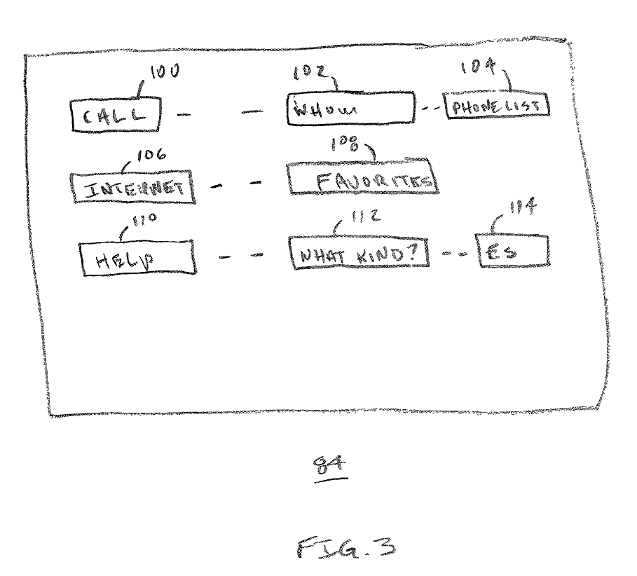

In the make-call example (FIG. 3), the recognition of the word “CALL” 100 may cause the CPU 68 to respond with a screen display inquiring as to the recipient of the call or asking for a telephone number. In order to return a response, the CPU 68 may compose a screen display with menu items, such as “CALL WHOM”, a call list or “ENTER CALLED NUMBER ___-___-____”. The CPU 68 may transfer the screen display through the codecs 54, 56 to the screen buffer 80 for presentation on the display 34. The CPU 68 may also transfer instructions through the codecs 54, 56 to the controller 82 activating the television 32 (if deactivated), or switching the television input from antenna or cable to the UseFullBox video output and/or possibly re-tuning the television 32 to an unused channel. Alternatively, if the television 32 has the capability for superimposing data displays on any channel, the CPU 68 may simply instruct the television to display the composed screen display over any current channel information.

To enhance the mobility of the user 14, alternate television sets 53 may be controlled by the CPU 68. To send messages to an alternate television set 53, the user 14 may simply state “go to set #2”.

In response to the display on the television or televisions 32, 53, the user 14 may enunciate a recipient's name on a telephone list or ask for a different telephone list. Alternatively, the user 14 may recite a telephone number of a call target. If the user 14 recites a name, then the CPU 68 may search a phone list 78 for a telephone number and display a number associated with the spoken name on the display 34. If the user 14 begins reciting numbers, the recognized numbers may be inserted into appropriate positions in the screen display of a number to be called. In any case, upon entry of a telephone number or selection on the display of the appropriate telephone number, the user 14 may complete the process by saying “PLACE CALL”.

Upon receiving and recognizing the “PLACE CALL” instruction, the CPU 68 may transfer the number to the telephone interface 66. The telephone interface 66, in turn, may transfer the telephone number to the PSTN 46. Upon completion of the telephone connection, the codecs may transfer voice information through the codecs using the second set of code plugs. The user 14 may then engage in a two-way conversation with the called party through a speakerphone made up of the speaker 36, amplifier 38 and audio coupler 64.

During the telephone call, the deactivation of the switch 20 on the UseFullWatch 16 prevents innocent comments of the telephone call from being interpreted as instructions to the UseFulCenter 52. At the end of the conversation, the user 14 may again activate the button 20 and say “HANG UP” to terminate the call. In response, the CPU 68 may instruct the telephone interface 66 to terminate the connection.

As another example, the user 14 may say “HELP”. The SR 62 may recognize the words and the CPU 68 may refer to the key word list 84 for an appropriate response. By reference to FIG. 3, recognition of the word “HELP” 110 may cause the CPU 68 to respond with a query of “WHAT KIND”. The CPU 68 may include a list of possible help options (e.g., medical emergency, fire, can't get up, burglary in progress, etc.).

In addition, the CPU 68 may also activate a timer 86. If the user 14 does not respond to the query as to the kind of help needed within a predetermined time period provided by the timer 86, the CPU 86 may retrieve a telephone number of an emergency service (ES) agency from the phone list 78. The retrieved telephone number may be transferred to the telephone interface 66. When a dispatcher answers, the CPU 68 may couple an audio playback unit 88 to the connection which may announce receipt of the help request and the address of the user 14.

In order to reduce the possibility of false alarms, a buzzer 55 may be provided for emergency calls. When the CPU 68 detects an emergency call, the CPU 68 activates the buzzer 55 through the codecs 54, 56. If no emergency exists, the user 14 may cancel the emergency call by simply stating “cancel”.

Alternatively, if the user 14 should respond with an indication of the type of help needed (by menu selection or recitation of explicitly specified needs), the CPU 68 may respond accordingly. If the help request were for assistance in getting up, the CPU 68 may direct the call to a local nurse who has a key to the user's home.

As other examples, the user may speak any of the words in the main menu (e.g., “MAIL”, “FAMILY”, “MONEY”, “FAVORITES”, “PARTNERS”, “HEALTH”, etc.) each of which may cause a user display customized to the interests and needs of the user.

As yet another example, the instruction detected by the UseFullWatch 16 may have been for access to the Internet 44. To facilitate Internet access, the browser 94 residing within the UseFullBox 30 may be used for the display of information. When the Internet title or address provided by the user 14 is interpreted by the CPU 68, the CPU 68 may download a HTML document or other coded language information from the Internet 44 to the browser 94 located in the UseFullBox 30. The browser 94 may then generate screens within the UseFullBox 30 that are transferred to the screen buffer 80 and then remotely displayed on the television 32.

Alternatively or in addition, a browser 69 may reside within or be connected to the CPU 68 and may be similarly controlled remotely by the user 14. In that case, screens generated by the browser 69 in the UseFullCenter 52 may be downloaded to the screen buffer 80 and remotely displayed on the television 32. The downloading of screens from the UseFullCenter 52 would be expected to require substantially greater bandwidth and/or download time.

To access the Internet, the user 14 may simply say “INTERNET”. By reference to the key word list 84, the CPU 68 may respond by directing the browser 94 within the UseFullBox 30 to generate a Welcome screen from image memory 96 within the CPU 92. The Welcome screen may offer the user 14 the option of selection from one or more favorites lists 74 (i.e., identified by URLs) or from a list of recently visited websites. These Welcome screens may be under the control of the browser 94, which retrieves them from memory 96. Any number of screens (e.g., 6) may be provided as part of a different favorites list 74. Further, an even larger number (e.g., 12) of most recently visited screens (i.e., websites) maybe accessed through the Welcome screen.

Alternatively or in addition, Welcome screens, lists of recently visited websites, and other specialized screens may be downloaded under control of the CPU 68 in the UseFullCenter 52, either using HTML or similar instructions to minimize download time or through full-image download. It is also possible that when the user 14 says “INTERNET”, that this may be directly interpreted within the recognition module 90 of the UseFullBox 30 in order to provide Welcome screens, etc., more promptly.

As above, the list of favorites 74 may be displayed through the screen buffer 80 on the television 32. Menu selection from the list 74 may be made using a voice-controlled cursor 35 and/or by instructions such as “SCROLL UP” or “SCROLL DOWN”, or “MOVE LEFT” or “MOVE RIGHT”. Highlighting text may be accomplished by simulated mouse commands such as “ACTIVATE CURSOR BUTTON” and “NEXT”, “MOVE LEFT” or “MOVE RIGHT” commands. Execution of a selected URL may be accomplished by recognition and execution of the instruction “GO THERE”, “O.K.”, or the like. Menu selection and execution of a selected URL may be accomplished either from the CPU 68 or by the HTML interpreter that is part of the browser 94 of the UseFullBox 30.

Execution of a particular URL may cause the CPU 68 to go to a selected website 70. Information downloaded to the CPU 68 may, in turn, be downloaded via HTML to the browser 94 within the UseFullBox 30, converted to an image by the browser 94, transferred to the screen buffer 80 and displayed on the television 32. Navigation may be accomplished using conventional controls augmented with word recognition, where appropriate.

For example, if the user should speak the word “YAHOO”, then the CPU 68 may construct the URL “http://yahoo.com” and use the constructed URL as a next web destination. Similarly, when arriving at the YAHOO website, any spoken words that follow may be inserted and used as search terms. When the user 14 has entered an appropriate set of search terms, he may recite the word “SEARCH”. In response, the CPU 68 may transmit the request to the search engine. In due course, the search engine will return a set of search results to the CPU 68. The CPU 68, in turn, may download the search results to the display 34.

Ambiguous terms (e.g., to/two/too) may result in a request for clarification. If the SR 62 cannot successfully resolve word identity, the CPU 68 may ask the user to spell a word.

As another example, the user 14 may access e-mail using the system 10. To access e-mail, the user 14 may simply say “E-MAIL”. In response, the CPU 68 may retrieve an e-mail menu 76, which, in turn, may be presented on the display 34. The user 14 may scroll up or down as described above. Individual e-mail messages may be selected by placing the cursor 35 over a message and instructing the CPU 68 to “OPEN” or by stating “DOUBLE CLICK” to simulate mouse operation.

Alternatively, the user 14 may instruct the CPU 68 to read the e-mail messages. The user 14 may highlight the message as discussed above or the user may simply say “read the first message”.

Under the illustrated embodiment, the CPU 68 may be provided with a suitable voice interface (e.g., by Dragon Systems, Inc.) 71. Using the voice interface 71, a complete set of e-mail commands may be provided which allow the user 14 to address and provide messaging content to the e-mail addressee using voice alone.

To facilitate and simplify use of the system 10, a technical support feature may be provided. Access to technical support personnel may be provided as part of the “HELP” menu. Upon requesting technical support, a telephone number of a technical support person may be retrieved from the phone list 78. A telephone connection may be set up between the speakerphone (i.e., the television 32) of the user and a telephone 49 of the technical support person. Screen information transmitted to the display 34 of the user may also be sent to a terminal 51 of the technical support person.

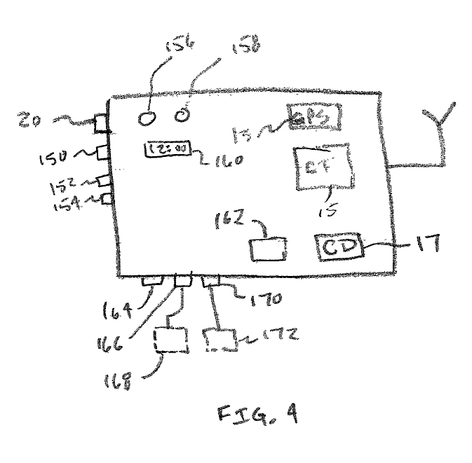

Under another illustrated embodiment of the invention, the CPU 68 may track remaining battery life within the UseFullWatch 16. The CPU 68 may track battery life by periodically querying a charge level detector 17 (FIG. 4) within the UseFullWatch 16 or by tracking an accumulated transmission time using a timer 87. In either case, when the UseFullWatch 16 reaches a discharge limit, the CPU 68 may transmit a warning to the user 14 of the need to recharge the battery within the UseFullWatch 16.

Under alternate embodiments of the invention, an emergency button 150 (FIG. 4) may be provided on the UseFullWatch 16. The emergency button 150 may be used in situations where the user 14 is incapacitated and cannot speak.

The UseFullWatch 16 and/or the UseFullBox 30 may also be provided with recall buttons 152, 154. For example, one button 152 may be used to recall a previous image. Another button 154 may be used to retrieve a next image.

Indicators 156, 158 may also be provided for various functions. One indicator 156 may be used to signal activation of the transmitter (i.e., transmission of a signal to the UseFullBox 30). Another indicator 158 may be used to signal low battery. A digital indicator 160 may be provided for a time display of a current time or remaining life in a rechargeable battery 162.

An accessory adapter 164 may also be provided. Such adapter 164 may be used to couple an electrocardiogram signal to an attending physician through the UseFullWatch 16, UseFullBox 30 and UseFulCenter 52.

Other accessory adapters 166, 168 may be provided for other functions. For example, a first adapter 166 may be provided for a cellular transmitter 168. The cellular transmitter 168 may be used to couple a signal from the user 14 directly to the UseFulCenter 52 where the user 14 goes outside his/her home. Further, a global positioning system (GPS) 172 may be coupled through another adapter 170. The GPS 172 may be used to locate the user 14 in the event the emergency button 150 is activated.

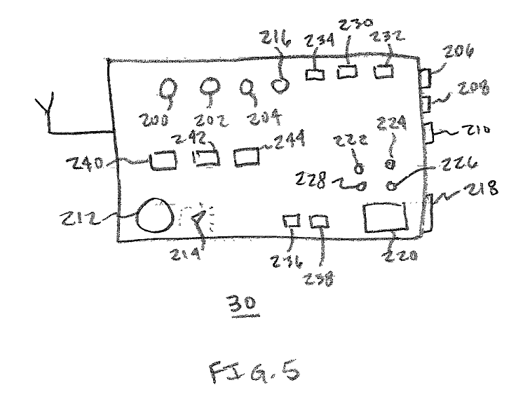

The UseFullBox 30 (FIG. 5) may be provided with similar functionality. A first indicator 200 may be provided for power on. A second indicator 202 may be provided to indicate receipt of a signal from the UseFullWatch 16. A third indicator 204 may be provided to indicate that the UseFullBox 30 is operating on battery backup. A message waiting indicator 216 may be provided to alert the user 14 to arriving e-mail messages. An emergency button 206 may be provided on the UseFullBox 30.

Image control buttons 208, 210 may also be provided. One button 208 may be provided to retrieve a last image. Another button 210 may be provided for a next image.

The UseFullBox 30 may also be equipped to operate as a speakerphone. A speaker 212 may be provided along with a volume control 214 in the situation where the television of the user 14 is not equipped to function as a speakerphone.

The UseFullBox 30 may also be provided with a receptacle 218 for the UseFullWatch 16. The receptacle 218 may be used to charge the battery 162 of the UseFullWatch 16.

A power receptacle 220 may be provided for control of the user's television (e.g., to turn it on). Receptacles 222, 224, 226 may be provided for attachment of the proper input (e.g., antenna, cable, fiber optic, etc.). An output receptacle 228 may be provided to couple an output signal to the television 32.

A telephone connector 230 may be provided to couple the UseFullBox 30 into the telephone system (i.e., the PSTN). A second connector 232 may be provided for a separate user telephone. Similarly, a jack 234 may be provided for an external speaker for a speakerphone.

A set of computer-style connectors 236, 238 may be provided. One connector 236 may be for an optional printer for printing screen displays. Another connector 238 may be provided for an optional monitor.

Included within the UseFullBox 30 may be a video switch 242. The video switch 242 may be useful where the television does not have the ability to internally process screen display data. In this case, the video switch 242 may switch between an external television signal from an antenna or cable and the buffer 80 as a signal source for the television 32.

Also included in the UseFullBox 30 may be a cradle for a cordless telephone. The cordless telephone may perform as a conventional cordless telephone; however, the cordless telephone may also serve as a substitute for the UseFullWatch 16. The cordless telephone may be provided with a pushbutton for initiating and maintaining a connection through the radio link 26 with the UseFullBox 30. The cordless telephone may also be programmed so that it receives voice and pushbutton signals from the user and transfers those signals to the UseFullBox 30. The UseFullBox 30 may function as described above to process signals received from the cordless telephone, instead of or in addition to the signals from the UseFullWatch 16.

A specific embodiment of a method and apparatus for providing access by a disabled user to a resource through one of a plurality of communication systems according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

1. A method of providing access by a user to a resource through one of a plurality of communication systems, such method comprising the steps of:
releasably connecting a microphone to a body part of the user;
detecting a voice signal of the user through the connected microphone;
transferring the detected voice signal of the user detected by the microphone to a local base unit;
recognizing at least some spoken words of the user;
associating the recognized words with a predetermined communication system of the plurality of communication systems;
executing a predetermined command to gain access to the resource based upon the recognized words through the associated communication system; and
displaying a status screen regarding the accessed resource on a television set of the user.

2. The method of providing access as in claim 1 further comprising seizing control of the television set of the user concurrently with execution of the predetermined command.

3. The method of providing access as in claim 1 wherein the step of recognizing at least some words further comprises recognizing a request for help.

4. The method of providing access as in claim 3 wherein the step of recognizing a request for help further comprises dialing a telephone number of a help resource.

5. The method of providing access as in claim 1 wherein the step of recognizing at least some words further comprises recognizing a request for Internet access.

6. The method of providing access as in claim 1 wherein the step of recognizing a request for Internet access further comprises displaying a menu of favorite sites on the television of the user.

7. The method of providing access as in claim 6 further comprising recognizing a selection from the menu of favorites.

8. The method of providing access as in claim 7 further comprising monitoring recognized words for entries within the menu of favorites.

9. The method of providing access as in claim 1 further comprising monitoring recognized words for key words in context.

10. The method of providing access as in claim 1 wherein the step of recognizing at least some words further comprising recognizing a request for telephone access.

11. The method of providing access as in claim 10 wherein the step of recognizing a request for telephone access further comprises coupling an audio connection to the user through the television.

12. The method of providing access as in claim 11 wherein the step of coupling an audio connection to the user through the television further comprises using the television as a speaker portion of a speakerphone.

13. The method of providing access as in claim 1 wherein the step of recognizing at least some words further comprising recognizing a request for e-mail access.

14. The method of providing access as in claim 1 wherein the step of recognizing a request for e-mail access further comprises displaying an e-mail directory of messages on the television of the user.

15. The method of providing access as in claim 1 wherein the step of displaying the e-mail directory further comprises monitoring for a selection within the directory.

16. The method of providing access as in claim 1 wherein the step of monitoring for a selection within the directory further comprises displaying a selection.

17. The method of providing access as in claim 1 wherein the step of displaying a selection further comprises matching a recognized word with an identifier of the selection.

18. An apparatus is provided for allowing access by a user to a resource through one of a plurality of communication systems, such apparatus comprising:
means for releasably connecting a microphone to a body part of the user;
means for detecting a voice signal of the user through the connected microphone;
means for transferring the detected voice signal of the user detected by the microphone to a local base unit;
means for recognizing at least some spoken words of the user;
means for associating the recognized words with a predetermined communication system of the plurality of communication systems;
means for executing a predetermined command to gain access to the resource based upon the recognized words through the associated communication system; and
means for displaying a status screen regarding the accessed resource on a television set of the user.

19. The apparatus for providing access as in claim 18 further comprising means for seizing control of the television set of the user concurrently with execution of the predetermined command.

20. The apparatus for providing access as in claim 18 wherein the means for recognizing at least some words further comprises means for recognizing a request for help.

21. The apparatus for providing access as in claim 20 wherein the means for recognizing a request for help further comprises means for dialing a telephone of a help resource.

22. The apparatus for providing access as in claim 18 wherein the means for recognizing at least some words further comprises means for recognizing a request for Internet access.

23. The apparatus for providing access as in claim 18 wherein the means for recognizing a request for Internet access further comprises means for displaying a menu of favorite sites on the television of the user.

24. The apparatus for providing access as in claim 23 further comprising means for recognizing a selection from the menu of favorites.

25. The apparatus for providing access as in claim 24 further comprising means for monitoring recognized words for entries within the menu of favorites.

26. The apparatus for providing access as in claim 18 further comprising means for monitoring recognized words for key words in context.

27. The apparatus for providing access as in claim 18 wherein the means for recognizing the at least some words further comprising means for recognizing a request for telephone access.

28. The apparatus for providing access as in claim 27 wherein the means for recognizing a request for telephone access further comprises means for coupling an audio connection to the user through the television.

29. The apparatus for providing access as in claim 28 wherein the means for coupling an audio connection to the user through the television further comprises means for using the television as a speakerphone.

30. The apparatus for providing access as in claim 18 wherein the means for recognizing at least some words further comprising means for recognizing a request for e-mail access.

31. The apparatus for providing access as in claim 18 wherein the means for recognizing a request for e-mail access further comprises means for displaying an e-mail directory of messages on the television of the user.

32. The apparatus for providing access as in claim 18 wherein the means for displaying the e-mail directory further comprises means for monitoring for a selection within the directory.

33. The apparatus for providing access as in claim 18 wherein the means for monitoring for a selection within the directory further comprises means for displaying a selection.

34. The method of providing access as in claim 18 wherein the means for displaying a selection further comprises means for matching a recognized word with an identifier of the selection.

35. An apparatus is provided for allowing access by a user to a resource through one of a plurality of communication systems, such apparatus comprising:
a connector adapted to releasably connect to a body part of the user;
a microphone coupled to the connector and adapted to detect a voice signal of the user;
a communication link adapted to transfer the detected voice signal of the user detected by the microphone to a local base unit;
a speech recognition unit adapted to recognize at least some spoken words of the user;
a key word table adapted to associate the recognized words with a predetermined communication system of the plurality of communication systems;
a processor adapted to execute a predetermined command to gain access to the resource based upon the recognized words through the associated communication system; and
a display adapted to display a status screen regarding the accessed resource on a television set of the user.

36. The apparatus for providing access as in claim 35 further comprising a controller adapted to seize control of the television set of the user concurrently with execution of the predetermined command.

37. The apparatus for providing access as in claim 35 further comprising a cordless telephone cradle disposed on the local base unit and adapted to receive voice and pushbutton signals from the user.

38. A method of providing access by a user to a communication system, such method comprising the steps of:
releasably connecting a microphone to a body of the user;
transferring a voice signal of the user detected by the microphone to a local base unit;
recognizing at least some spoken words of the user; and
displaying a predetermined command associated with the recognized spoken words on a television set of the user through the base unit.
